(19) United States
(12) Patent Application Publication
(10) Pub. No.: US 2014/0298932 A1
(43) Pub. Date: Oct. 9, 2014

(54) ENDOSCOPE APPARATUS

(71) Applicant: OLYMPUS MEDICAL SYSTEMS CORP., Tokyo (JP)

(72) Inventor: Yasuhiro OKAMOTO, Tokyo (JP)

(73) Assignee: OLYMPUS MEDICAL SYSTEMS CORP., Tokyo (JP)

(21) Appl. No.: 14/277,243

(22) Filed: May 14, 2014

Related U.S. Application Data
(63) Continuation of application No. PCT/JP2013/081500, filed on Nov. 22, 2013.

(30) Foreign Application Priority Data
Nov. 27, 2012 (JP) 2012-258982

(51) Int. Cl. F16H 19/06

(52) U.S. Cl. CPC F16H 19/06
USPC 74/25

(57) ABSTRACT

An endoscope apparatus includes: an insertion portion; an insertion assisting mechanism portion that is provided on an outer circumference of the insertion portion and is rotatable in a first rotational direction, or a second rotational direction that is the opposite direction to the first rotational direction; a drive portion that generates a driving force for causing the insertion assisting mechanism portion to rotate; a drive shaft that can be rotated by a driving force of the drive portion, and with respect to which a torsional rigidity in a fourth rotational direction that is an opposite direction to a third rotational direction is set so as to be higher than a torsional rigidity in the third rotational direction; and a drive mechanism portion that, by means of the drive shaft rotating in the fourth rotational direction, causes the insertion assisting mechanism portion to rotate in the first rotational direction.

### CROSS REFERENCE TO RELATED APPLICATION

This application is a continuation application of PCT/JP2013/081500 filed on Nov. 22, 2013 and claims benefit of Japanese Application No. 2012-258982 filed in Japan on Nov. 27, 2012, the entire contents of which are incorporated herein by this reference.

### BACKGROUND OF THE INVENTION

1. Field of the Invention

The present invention relates to an endoscope apparatus that includes an endoscope having an insertion portion that is to be inserted into a part to be examined, and a mechanism portion that drives a functional portion that is provided in the insertion portion of the endoscope.

2. Description of the Related Art

Endoscopes are utilized in a medical field and an industrial field and the like. An endoscope includes an insertion portion that is to be inserted into a part to be examined. With an endoscope used in the medical field, observation of an organ or the like can be performed by inserting an elongated insertion portion into the body. In addition, various kinds of treatment and the like can be performed by introducing a treatment instrument into the body through a treatment instrument insertion channel provided in the endoscope.

With an endoscope used in the industrial field, by inserting an elongated insertion portion thereof into a jet engine or pipes of a factory or the like, it is possible to carry out an inspection to observe the presence or absence of flaws or corrosion or the like.

Some endoscopes are provided with a bending portion that has a bending function as a functional portion in the insertion portion. In an endoscope equipped with a bending portion, for example, a knob for upward/downward bending or a knob for left/right bending is provided in an operation portion. A user can bend the bending portion by rotating the knob for upward/downward bending or the knob for left/right bending and thereby change the direction of a distal end portion of the insertion portion to a desired direction.

In order to lessen the burden on the user when pulling wires, an endoscope with an electrical bending mechanism has been realized that uses an electrical mechanism to drive a bending portion.

An electrical bending mechanism, an insertion assisting mechanism, and a power-assist mechanism are known as electrical mechanisms that reduce the burden of a surgeon when provided in an endoscope.

An insertion assisting mechanism is rotatably disposed with respect to an outer circumferential face of the insertion portion of an endoscope. The insertion assisting mechanism includes a helical-shaped portion as a functional portion. The helical-shaped portion is rotated around the axis of the insertion portion by a driving force of a motor. The helical-shaped portion that is rotated is an electrical mechanism that imparts a propulsive force to the insertion portion.

On the other hand, the power-assist mechanism is, for example, provided inside the operation portion. The power-assist mechanism includes a pulley as a functional portion on which a bending wire is wound. The pulley is constantly rotated by the driving force of a motor. The power-assist mechanism transmits a rotary force of the pulley to a bending wire that corresponds to the direction of a bending operation and which is wound around the pulley. The power-assist mechanism is an electrical mechanism that reduces the amount of force of a wire pulling operation.

The electrical mechanism includes, for example, a motor as a drive portion. The motor is provided inside the operation portion of the endoscope, inside a connector portion, or inside an external apparatus of the endoscope or the like. The electrical mechanism includes a transmitting member that transmits a rotational driving force of the motor. The transmitting member is a gear or a drive shaft or the like.

For example, Japanese Patent Application Laid-Open Publication No. 2010-213969 discloses an endoscope that can exert a power-assist function having favorable operability without increasing the size or weight of the operation portion of the main body, even in a case where an operation assisting force is further increased and is generated with greater accuracy.

In the endoscope disclosed in the aforementioned Japanese Patent Application Laid-Open Publication No. 2010-213969, a driving force transmitting mechanism is provided that enables transmission of a rotational driving force with a high degree of angular accuracy. In the driving force transmitting mechanism, wire members are provided with respect to a pulley so that, regardless of whether the rotational direction of the drive motor is forward or rearward, a twisting direction on the outermost layer of a wire of any one of the wire members matches the rotational direction. The wire members are flexible shafts. The flexible shafts are members that transmit a rotary force of the drive motor, and two flexible shafts are provided. A drive gear and a driven gear are provided at the end portions of two wire members, respectively. The respective driven gears intermesh with an output-side gear that is provided on a pulley as a drive mechanism portion. The respective drive gears intermesh with an input-side gear provided on a drive motor.

Note that in Japanese Patent Application Laid-Open Publication No. 2010-213969, it is disclosed that wires as inner shafts exist for right rotation and for left rotation in accordance with the twisting direction of the outermost layer. It is also disclosed that the strength of a wire with respect to twisting is increased by matching the twisting direction of the outermost layer of the relevant wire with the rotational direction, and that in addition to the rotational accuracy being increased, angle errors in the twisting direction of the wire as well as changes over time can be decreased.

### SUMMARY OF THE INVENTION

An endoscope apparatus according to one aspect of the present invention includes: an insertion portion to be inserted into a subject; an insertion assisting mechanism portion that is provided on an outer circumference of the insertion portion and is rotatable in a first rotational direction for advancing the insertion portion inside the subject, or a second rotational direction that is an opposite direction to the first rotational direction and is a direction for retracting the insertion portion towards outside of the subject; a drive portion that generates a driving force for causing the insertion assisting mechanism portion to rotate with respect to the insertion portion; a drive shaft that can be rotated by a driving force of the drive portion, and a torsional rigidity of the drive shaft in a fourth rotational direction that is an opposite direction to a third rotational direction is set so as to be higher than a torsional rigidity in the third rotational direction; and a drive mechanism portion that, by means of the drive shaft rotating in the fourth rotational direction, causes the insertion assisting mechanism portion to rotate in the first rotational direction.

### BRIEF DESCRIPTION OF THE DRAWINGS

FIG. 1 to FIG. 3 relate to a first embodiment of the present invention, of which FIG. 1 is a view that illustrates an endoscope apparatus according to the first embodiment;

FIG. 2 is a view that illustrates an electrical bending mechanism that actuates a bending function of a bending portion of the endoscope illustrated in FIG. 1 by electrical driving;

FIG. 3 is a view that illustrates a configuration example of an operation portion of the endoscope in which, among the bending functions of the bending portion, bending in the upward/downward directions is performed by a manual operation and bending in the left/right directions is performed by electrical driving;

FIG. 4 to FIG. 7 relate to a second embodiment of the present invention, of which FIG. 4 is a view that illustrates an endoscope apparatus according to the second embodiment;

FIG. 5 is a view that illustrates an insertion portion and an insertion assisting mechanism provided on the insertion portion;

FIG. 6 is a view that illustrates a relation between the insertion assisting mechanism provided on the insertion portion, and a mechanism portion that causes the insertion assisting mechanism to rotationally operate by electrical driving;

FIG. 7 is a cross-sectional view along a line Y7-Y7 in FIG. 6;

FIG. 8 and FIG. 9 relate to a third embodiment of the present invention, of which FIG. 8 is a view that illustrates an endoscope apparatus according to the third embodiment; and

FIG. 9 is a view that illustrates a power-assist mechanism that actuates a bending function of a bending portion by electrical driving.

### DETAILED DESCRIPTION OF THE PREFERRED EMBODIMENTS

Embodiments of the present invention will be described hereunder with reference to the drawings.

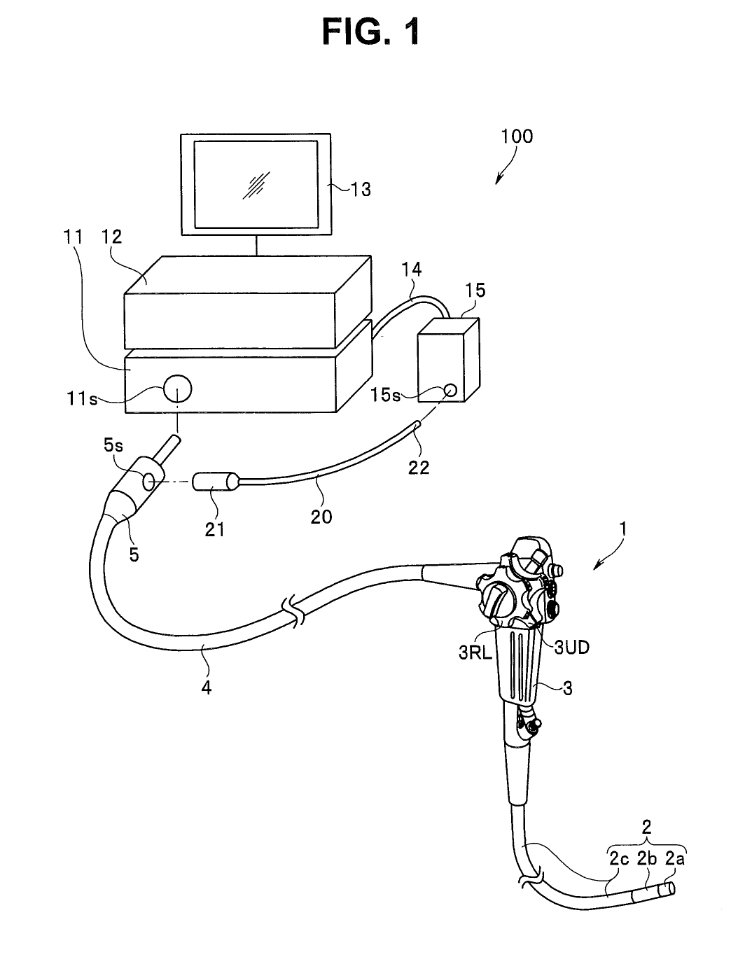

A first embodiment of the present invention will be described with reference to FIG. 1 to FIG. 3.

As shown in FIG. 1, an endoscope apparatus 100 of the present embodiment includes an endoscope 1, a light source apparatus 11 that is an external apparatus of the endoscope, a display processor 12, a monitor 13, and a control apparatus 15 as principal components. Reference numeral 14 denotes a connection cable that electrically connects the light source apparatus 11 and the control apparatus 15.

The endoscope 1 includes an elongated insertion portion 2 that is inserted, for example, into the body. An operation portion 3 is provided at a proximal end of the insertion portion 2. A universal cord 4 extends from the operation portion 3. A connection connector 5 that is detachably attachable to the light source apparatus 11 is provided at an extending end of the universal cord 4.

A bending portion 2b having an upward/downward bending functional portion and a left/right bending functional portion is provided on a distal end portion 2a side of the insertion portion 2.

In the present embodiment, the endoscope 1 is, for example, an esophagogastroduodenoscope. The upward/downward bending functional portion is equipped with a first function and a second function. In the upward/downward bending functional portion, an upward bending angle of the bending portion 2b is set to a larger angle than a downward bending angle thereof. Accordingly, if a pulling force when bending the bending portion 2b in the upward direction and a pulling force when bending the bending portion 2b in the downward direction are compared, the pulling force when bending the bending portion 2b in the upward direction will be greater than the pulling force when bending the bending portion 2b in the downward direction.

That is, the second function of the upward/downward bending functional portion is a function that bends the bending portion in the upward direction as a second bending direction, and the first function is different to the second function and is a function that bends the bending portion in the downward direction as a first bending direction that is the opposite direction to the upward direction.

The bending portion 2b is configured so as to perform a bending operation under a rotational driving force of a drive motor as a drive portion that is described later. Reference character 2c denotes a flexible tube portion that has flexibility.

In the operation portion 3, an upward/downward bending operation instruction knob 3UD and a left/right bending operation instruction knob 3RL are provided as operation instruction members. The upward/downward instruction knob 3UD and the left/right instruction knob 3RL are each rotatable around the axis of an unshown shaft.

The connection connector 5 is detachably attachable to a connector connection portion 11s of the light source apparatus 11. The light source apparatus 11 is electrically connected to the display processor 12 by an unshown connection cable. The display processor 12 is electrically connected to the monitor 13. The control apparatus 15 includes a control portion (unshown) that performs control for electrically driving the bending portion 2b.

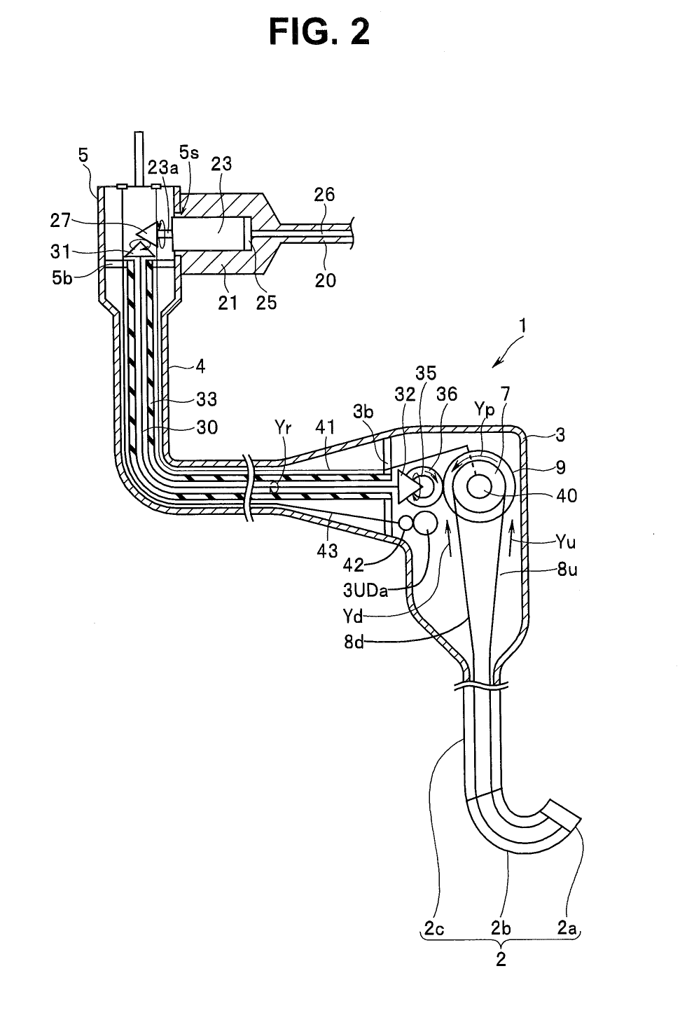

A cable connection portion 5s is provided as an attachment/detachment portion in the connection connector 5. A first connection portion 21 of a drive cable 20 is detachably attachable to the cable connection portion 5s. A second connection portion 22 is positioned on the opposite side to the first connection portion 21 on the drive cable 20. The second connection portion 22 is detachably attachable to an apparatus connection port 15s of the control apparatus 15. In a state in which the second connection portion 22 is connected to the apparatus connection port 15s, a control signal generated by the control portion is outputted to a drive motor (see reference number 23 in FIG. 2) provided inside the first connection portion 21 of the drive cable 20.

A mechanism portion that causes a bending function of the endoscope apparatus 100 to perform a bending operation by electrical driving will now be described referring to FIG. 2.

Note that, to simplify the drawing, the configuration of the mechanism portion that drives the upward/downward bending function by electrical driving is described with respect to the bending portion 2b in FIG. 2, and a description of the left/right bending function is omitted.

The mechanism portion (hereunder, referred to as “electrical bending mechanism”) that drives the bending portion 2b to bend by electrical driving mainly includes a drive motor (hereunder, abbreviated to “motor”) 23, a drive shaft 30, and a pulley 7.

As shown in FIG. 2, the motor 23 is provided inside the first connection portion 21 of the drive cable 20. The motor 23 is a drive portion. The motor 23 generates a driving force for causing the bending portion 2b to perform a bending operation. The motor 23 is driven based on a control signal and electrical power outputted from the control apparatus 15. A rotational driving force of the motor 23 is transmitted to a drive mechanism portion through the drive shaft 30.

An unshown power cable is inserted through the drive cable 20 and connected to the motor 23. Reference numeral 25 denotes a motor encoder. Reference numeral 26 denotes a first cable. The first cable 26 extends from the motor encoder 25.

The rotational amount of the motor 23 is detected with the motor encoder 25. A detection value that is detected is outputted to the control apparatus 15 through the first cable 26.

A driving-force feeding bevel gear (abbreviated to “feeding gear”) 27 is provided on a rotary shaft 23a of the motor 23. The rotary shaft 23a is rotatable in a clockwise direction and a counterclockwise direction.

The drive shaft 30 is a driving force transmitting member. The drive shaft 30 transmits the driving force of the motor 23 to the pulley 7. A first bevel gear 31, for example, is fixedly provided at a first end of the drive shaft 30. A second bevel gear 32 is fixedly provided at a second end of the drive shaft 30. The first bevel gear 31 is configured so as to intermesh with the feeding gear 27.

The drive shaft 30 is a flexible shaft. The outer circumference of the drive shaft 30 is covered by a protective tube 33, and the drive shaft 30 is inserted through the inside of the universal cord 4 in the covered state. The drive shaft 30 is arranged in a loosely fitting state inside the protective tube 33. That is, the drive shaft 30 is rotatable inside the tube 33.

A shaft for right rotation and a shaft for left rotation that depend on the winding direction are available as a flexible shaft that constitutes the drive shaft 30. The drive shaft 30 of the present embodiment is a shaft for right rotation that rotates in a second rotational direction as shown by an arrow Yr. In the drive shaft 30, a torsional rigidity with respect to right rotation is set so as to be higher than a torsional rigidity with respect to left rotation.

Note that the rigidity of the drive shaft 30 is appropriately set depending on the twisting direction of the wire constituting the shaft and the winding direction of a wire member constituting the shaft and the like.

An end portion on a first end side of the protective tube 33 is fixed in a predetermined positional relation with respect to a first receiving member 5b provided in the connection connector 5. Further, an end portion on a second end side of the protective tube 33 is fixed in a predetermined positional relation with respect to a second receiving member 3b provided in the operation portion 3.

The first end of the drive shaft 30 protrudes more than the end portion on the first side of the protective tube 33. Further, the second end of the drive shaft 30 protrudes more than the end portion on the second end side of the protective tube 33.

The pulley 7, a pulley potentiometer 40, and a knob shaft potentiometer 42 are provided inside the operation portion 3. The pulley 7 is rotatable. The pulley potentiometer 40 detects a rotational amount of the pulley 7. The knob shaft potentiometer 42 detects a rotational amount of a knob shaft 3UDa of the upward/downward bending operation instruction knob 3UD.

Reference numeral 43 denotes a second cable. The second cable 43 extends from the knob shaft potentiometer 42. A configuration is adopted so that a detection value detected by the knob shaft potentiometer 42 is inputted to the control apparatus 15 through the second cable 43 and the like.

When the pulley 7 is rotated to cause a bending wire to be pulled or slackened, the pulley 7 thereby causes the bending portion 2b to bend upward or bend downward. Accordingly, the proximal end of an upward bending wire (hereunder, abbreviated to “upward wire”) 8u and the proximal end of a downward bending wire (hereunder, abbreviated to “downward wire”) 8d are fixedly provided on the pulley 7. The distal end of the upward wire 8u is fixedly provided in a predetermined upward direction of the bending portion 2b. The distal end of the downward wire 8d is fixedly provided in a predetermined downward direction of the bending portion 2b.

The pulley 7 is included in the drive mechanism portion. The drive mechanism portion is constituted by the pulley 7, a first spur gear 9, a second spur gear 36, and a driving-force receiving bevel gear (hereunder, referred to as “receiving gear”) 35. The first spur gear 9 is provided integrally with the pulley 7. The receiving gear 35 is provided integrally with the second spur gear 36.

The pulley 7 can rotate together with the first spur gear 9. The second spur gear 36 can rotate together with the receiving gear 35. The second spur gear 36 is provided inside the operation portion 3. The second spur gear 36 is intermeshed with the first spur gear 9. The second bevel gear 32 of the drive shaft 30 is intermeshed with the receiving gear 35.

A configuration is adopted such that the feeding gear 27 and the first bevel gear 31 intermesh when the first connection portion 21 of the drive cable 20 is connected to the cable connection portion 5s of the connection connector 5. In a state in which the drive cable 20 is connected to the connection connector 5, the drive shaft 30 rotates in the first rotational direction or the second rotational direction when the motor 23 is driven. The configuration illustrated in FIG. 2 is one in which the drive shaft 30 rotates in the second rotational direction when the rotary shaft 23a of the motor 23 is rotated in the clockwise direction.

When the pulley 7 is rotated in the direction of an arrow Yp in the figure, the pulley 7 pulls the upward wire 8u in the direction of an arrow Yu in the figure. The bending portion 2b bends in the upward direction when the upward wire 8u is pulled in the direction of the arrow Yu. On the other hand, the bending portion 2b bends in the downward direction when the pulley 7 is rotated in the opposite direction to the direction of the arrow Yp in the figure and pulls the downward wire 8d in the direction of an arrow Yd in the figure.

Note that reference numeral 41 denotes a third cable. The third cable 41 extends from the pulley potentiometer 40. A detection value detected by the pulley potentiometer 40 is inputted to the control apparatus 15 through the third cable 41 and the like.

An action of the endoscope apparatus 100 will now be described.

In the endoscope apparatus 100, the connection connector 5 of the endoscope 1 is connected to the connector connection portion 11s. The first connection portion 21 of the drive cable 20 is connected to the connection portion 5s of the connection connector 5. The second connection portion 22 of the drive cable 20 is connected to the apparatus connection port 15s of the control apparatus 15.

When operating the endoscope 1 of the endoscope apparatus 100, a surgeon places the light source apparatus 11, the display processor 12, the monitor 13, and the control apparatus 15 in a driven state. In this state, when bending the bending portion 2b in, for example, the upward direction, the surgeon rotationally operates the upward/downward bending operation instruction knob 3UD in one direction. Thereupon, the knob shaft 3UDa of the upward/downward bending operation instruction knob 3UD rotates, and the rotational direction and rotational amount thereof is outputted to the control apparatus 15 through the knob shaft potentiometer 42.

The control portion of the control apparatus 15 generates a motor driving signal that corresponds to the detection result, and outputs the driving signal to the motor 23. As a result, the rotary shaft 23a of the motor 23 is rotated clockwise. The rotational driving force of the motor 23 is transmitted to the drive shaft 30 via the feeding gear 27 and the first bevel gear 31. As a result, the drive shaft 30 rotates in the second rotational direction.

The rotation of the drive shaft 30 is transmitted via the second bevel gear 32 to the receiving bevel gear 35, and thereafter is transmitted to the pulley 7 via the second spur gear 36 and the first spur gear 9. As a result, the pulley 7 is rotated in the arrow Yp direction, the upward wire 8u is pulled in the arrow Yu direction, and the bending portion 2b bends in the upward direction. That is, the bending portion 2b is electrically bent in the upward direction by the rotational driving force of the motor 23.

At such time, the rotational amount of the motor 23 is detected by the encoder 25. Further, the rotational amount of the pulley 7 is detected by the pulley potentiometer 40. The detection results are outputted to the control apparatus 15, respectively.

The bending portion 2b enters a bending state that is desired by the surgeon as a result of the bending amount of the bending portion 2b, that is, the rotational amount of the pulley 7 matching the amount of rotational operation of the upward/downward bending operation instruction knob 3UD.

Note that, if the surgeon rotationally operates the upward/downward bending operation instruction knob 3UD in another direction that is the opposite direction to the direction described above, the rotational direction and rotational amount of the knob shaft 3UDa of the upward/downward bending operation instruction knob 3UD are outputted to the control apparatus 15 via the knob shaft potentiometer 42 as described above. The control portion of the control apparatus 15 generates a motor driving signal and outputs the driving signal to the motor 23.

As a result, the rotary shaft 23a of the motor 23 is rotated counterclockwise, and the rotational driving force is transmitted to the pulley 7 in a similar manner as described above. At this time, the pulley 7 is rotated in the opposite direction to the arrow Yp direction, the downward wire 8d is pulled, and the bending portion 2b is electrically bent in the downward direction.

Further, in the present embodiment, a configuration has been described in which the motor 23 is provided inside the drive cable 20, and the bending portion 2b is electrically bent in the upward and downward directions. However, a motor 23 that electrically bends the bending portion 2b in the left/right directions is also provided inside the drive cable 20. Therefore, by simultaneously operating the bending operation knobs 3UD and 3RL, it is also possible to cause the bending portion 2b to bend in a direction that combines either one of the upward and downward directions with either one of the left and right directions, for example, the right-upward direction or the left-downward direction.

Thus, an endoscope is constructed in which the rotational driving force of the motor 23 is transmitted from the first end of the drive shaft 30 to the second end thereof to rotate the pulley 7 and electrically bend the bending portion 2b in a desired direction. In this configuration, the winding direction in which the torsional rigidity of the drive shaft 30 is set to be higher, the rotational direction of the drive shaft 30, and a rotational direction in which the pulling force of the pulley 7 is large are made to match each other.

Consequently, when transmitting the rotational driving force of the motor 23 to the pulley 7 through the drive shaft 30, the drive shaft 30 is twisted in the winding direction. Therefore, when transmitting a rotational driving force, the drive shaft 30 can reliably transmit the rotational driving force without the transmission efficiency decreasing, and can cause the bending portion 2b to bend as far as the maximum bending angle.

Further, in a downward bending endoscope, when an upward bending angle and a downward bending angle are equal and a right direction bending angle and a left bending angle are equal, for example, in a case where a bending operation frequency in the right direction is greater than a bending operation frequency in the left direction, the winding direction in which the torsional rigidity of the drive shaft 30 is set to be higher, the rotational direction of the drive shaft 30, and the rotational direction of the pulley 7 in which the bending operation frequency is greater are made to match each other.

As a result, the repetition durability of the drive shaft 30 can be improved and repeated bending of the bending portion 2b in the right direction can be stably performed.

Note that in a case where it is attempted to rotate the drive shaft 30 in the first rotational direction that is the opposite direction to the direction in which the torsional rigidity of the shaft 30 is set to a high torsional rigidity, transmit the rotational driving force of the motor 23 to the drive mechanism portion to rotate the pulley 7, and bend the bending portion as far as the maximum angle in the upward direction, the drive shaft 30 will be twisted in the opposite direction to the winding direction. Consequently, there is a risk that the transmission efficiency of the rotational driving force will decrease and it will be difficult to transmit an adequate rotational driving force, or that the repetition durability of the drive shaft 30 will decrease and the bending performance in the right direction for which the bending operation frequency is high will become unstable.

Further, in the present embodiment, the bending operation knobs 3UD and 3RL are illustrated as operation instruction members that are operated to bend the bending portion 2b. However, an operation instruction member is not limited to the knobs 3UD and 3RL, and may also be a joy stick or a trackball or the like.

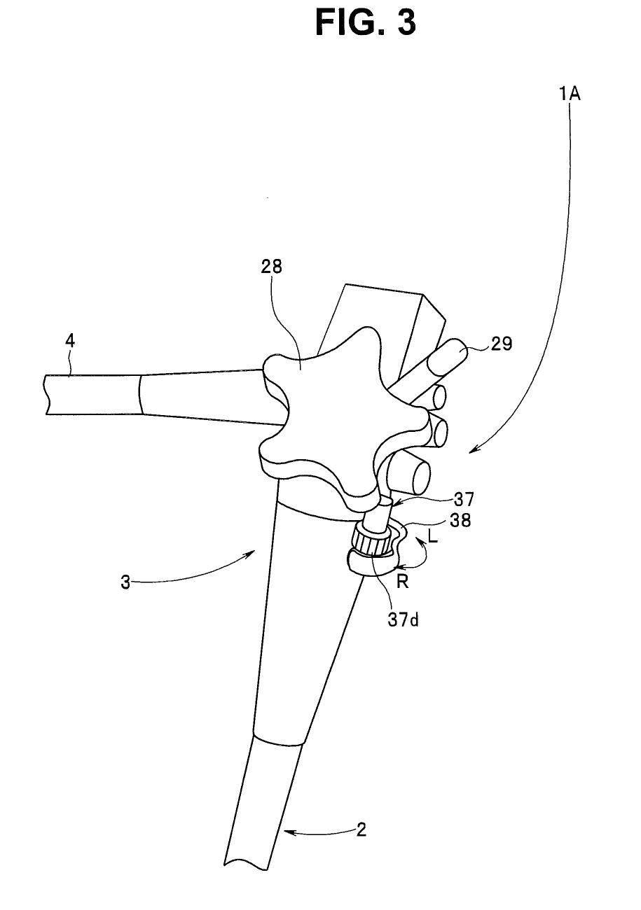

Further, for example, a configuration of an endoscope 1A as shown in FIG. 3 may also be adopted in which an upward/downward bending operation knob 28 is provided with which a bending wire is manually pulled to bend the bending portion in, for example, the upward/downward directions, and a left/right bending operation apparatus 37 is provided with which a bending wire is pulled by electrical driving to bend the bending portion in, for example, the left/right directions.

In this configuration, there is one motor 23. Reference numeral 29 denotes an upward/downward bending fixing/releasing knob. Reference character 37d denotes a rotary dial. The rotary dial 37d is rotatable in an arrow R direction, and an arrow L direction that is the opposite direction to the arrow R direction. Reference numeral 38 denotes a protruding portion. The protruding portion 38 is an erroneous operation prevention wall, and prevents the surgeon's fingers from erroneously contacting the rotary dial 37d.

According to the endoscope 1A, by rotating the rotary dial 37d, for example, in the arrow R direction, the rotational driving force of the motor 23 can be transmitted to an unshown pulley, and the bending portion can be electrically bent in the right direction.

Note that, conversely to the above described configuration, a configuration may also be adopted in which bending of the bending portion 2b in the upward/downward directions is performed by electrical driving and bending of the bending portion 2b in the left/right directions is performed by manual operation.

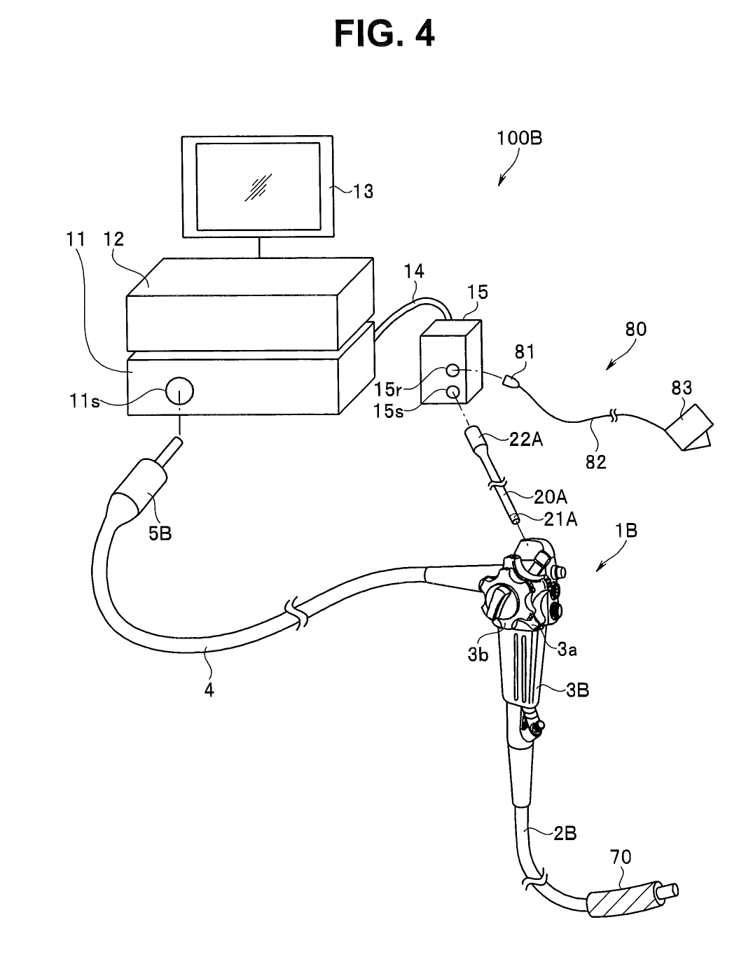

A second embodiment of the present invention will now be described referring to FIG. 4 to FIG. 7.

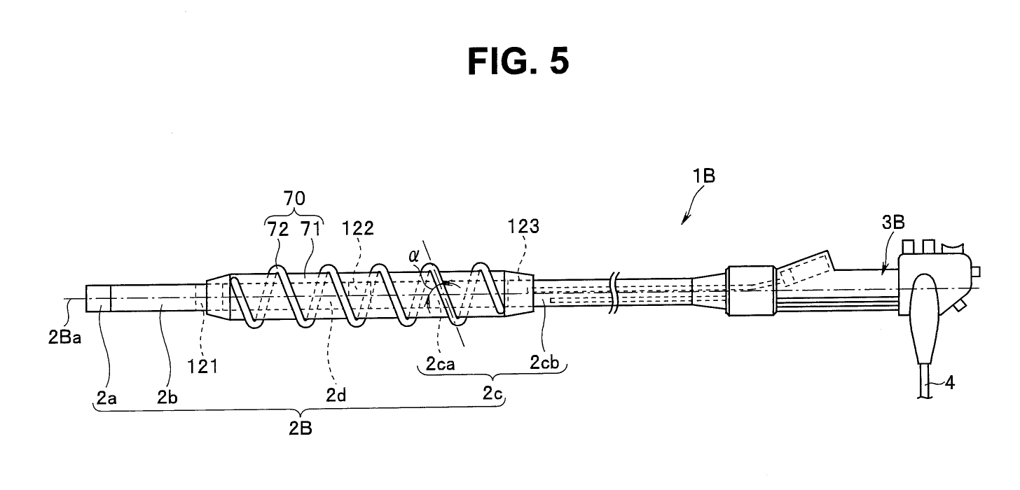

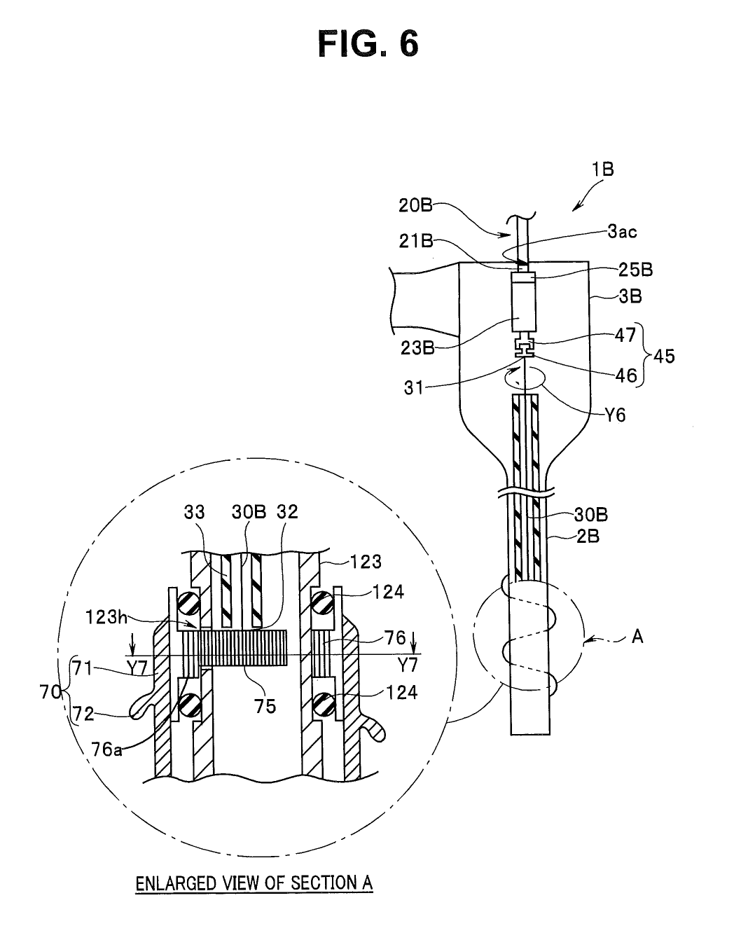

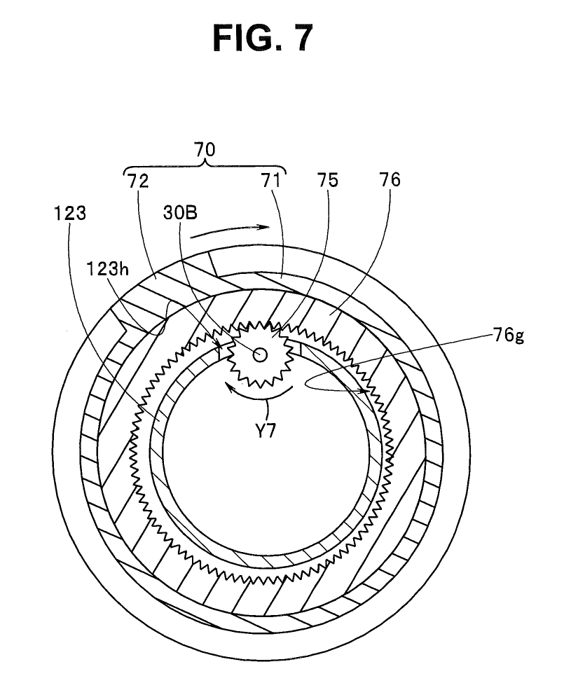

FIG. 4 is a view that illustrates an endoscope apparatus of the second embodiment. FIG. 5 is a view that illustrates an insertion portion and an insertion assisting mechanism provided on the insertion portion. FIG. 6 is a view that illustrates a relation between the insertion assisting mechanism provided on the insertion portion, and a mechanism portion that causes the insertion assisting mechanism to rotationally operate by electrical driving. FIG. 7 is a cross-sectional view along a line Y7-Y7 in FIG. 6. Note that members that are the same as in the above described embodiment are denoted by the same reference numerals and a description of such members is omitted hereunder.

As shown in FIG. 4, an endoscope apparatus 100B of the present embodiment includes an endoscope 1B, the light source apparatus 11 that is an external apparatus of the endoscope, the display processor 12, the monitor 13, and the control apparatus 15 as principal components.

The endoscope 1B has an elongated insertion portion 2B. In the present embodiment, an insertion assisting mechanism portion 70 is provided on the outer circumference of a distal end side of the insertion portion 2B. The insertion assisting mechanism portion 70 is a functional portion that improves the insertability of the insertion portion 2 into a subject and the extractability of the insertion portion 2 from the subject.

In the present embodiment, an electrical connection portion that is described later is provided in an operation portion 3A of the endoscope 1B. Reference numeral 80 denotes an insertion assisting mechanism operation switch (hereunder, abbreviated as “external switch”).

The external switch 80 includes a footswitch connector portion 81, a footswitch cable 82, and a footswitch portion 83. The footswitch connector portion 81 is detachably attached to a footswitch connection port 15r of the control apparatus 15.

Note that in the present embodiment, a bending portion 2b having an upward/downward bending functional portion and a left/right bending functional portion is provided on the distal end portion 2a side of the insertion portion 2. The bending portion 2b has a conventional configuration in which a bending operation is performed by manually pulling a bending wire. Accordingly, a description of the configuration that causes the bending portion 2b to bend is omitted here.

An upward/downward bending knob 3a or a left/right bending knob 3b is disposed on the operation portion 3 that is provided at the proximal end of the insertion portion 2. The endoscope 1B may also be configured to include the electrical bending mechanism described in the foregoing first embodiment.

As shown in FIG. 5, the insertion assisting mechanism portion 70 is rotatably disposed on a predetermined outer circumferential face of the insertion portion 2B.

The insertion portion 2B is configured to include, in order from the distal end side, the distal end portion 2a, the bending portion 2b, a passive bending portion 2d, and a flexible tube portion 2c. In contrast to the bending portion 2b that performs a bending operation when a bending wire is pulled or slackened, the passive bending portion 2d passively bends upon receiving an external force. The flexible tube portion 2c of the present embodiment includes a first flexible tube 2ca and a second flexible tube 2cb. The first flexible tube 2ca is positioned on the distal end side of the flexible tube 2c. The second flexible tube 2cb is connected to the proximal end of the first flexible tube 2ca.

The bending portion 2b and the passive bending portion 2d are connected through a first connecting tube 121. The passive bending portion 2d and the first flexible tube 2ca are connected through a second connecting tube 122. The first flexible tube 2ca and the second flexible tube 2cb are connected through a third connecting tube 123. The first connecting tube 121 and the third connecting tube 123 also serve as insertion assisting mechanism attachment portions. One end of the insertion assisting mechanism portion 70 is attached to the first connecting tube 121. The other end of the insertion assisting mechanism portion 70 is attached to the third connecting tube 123.

The insertion assisting mechanism portion 70 is configured so as to rotate in the clockwise direction and counterclockwise direction around an axis 2Ba of the insertion portion 2.

The insertion assisting mechanism portion 70 is configured to include a tube body 71 and a helical-shaped portion 72. The helical-shaped portion 72 is a helical-shaped convex portion that protrudes from the outer circumferential face of the tube body 71. The convex portion constituting the helical-shaped portion 72 protrudes by a predetermined amount from the outer circumferential face of the tube body 71 towards the outer side in the diametrical direction of the tube body 71. The helical-shaped portion 72 is wound in a helical shape at an angle α so that the angle α becomes greater than, for example, 45° with respect to the axis 2Ba. The insertion assisting mechanism portion 70 imparts a propulsive force to the insertion portion 2 by a screwing action that arises when the helical-shaped portion 72 comes in contact with a body cavity wall accompanying rotation.

In the present embodiment, a configuration is adopted so that when the helical-shaped portion 72 rotates clockwise (in the second rotational direction) as viewed from the operation portion 3B side, a first propulsive force is obtained that advances the insertion 2B towards a deep portion of the body cavity. Conversely, when the helical-shaped portion 72 rotates counterclockwise (in the first rotational direction) as viewed from the operation portion 3B side, a second propulsive force is obtained that causes the insertion 2B to retract towards the outside from a deep portion of the body cavity.

When a load applied to the insertion assisting mechanism portion 70 at a time of advancing the insertion portion 2B by means of the first propulsive force and a load applied to the insertion assisting mechanism portion 70 at a time of retracting the insertion portion 2B by means of the second propulsive force are compared, it is found that the load applied to the insertion assisting mechanism portion 70 at a time of advancing is greater than the load applied to the insertion assisting mechanism portion 70 at a time of retracting.

Note that the insertion assisting mechanism portion 70 may also be configured so that the first propulsive force is obtained by rotating the helical-shaped portion 72 in the first rotational direction and the second propulsive force is obtained by rotating the helical-shaped portion 72 in the second rotational direction.

The mechanism portion that causes the insertion assisting mechanism portion 70 provided on the insertion portion 2B of the endoscope 1B to rotationally operate by electrical driving will now be described referring to FIG. 6.

As shown in FIG. 6, the mechanism portion that rotates the insertion assisting mechanism portion 70 to generate a propulsive force includes a motor 23B, a drive shaft 30B, and a tube body rotation portion 76 as principal components.

In the present embodiment, the motor 23B is provided, for example, inside the operation portion 3B. The motor 23B is a drive portion. The motor 23B generates a driving force for rotationally operating the insertion assisting mechanism portion 70. The motor 23B is driven based on a control signal and electric power outputted from the control apparatus 15.

In the present embodiment, a configuration is adopted so that the state of the motor 23B can be switched between a stopped state, a state of rotation in the clockwise direction, and a state of rotation in the counterclockwise direction by the external switch 80 shown in FIG. 4.

A switching switch (unshown) is provided in the footswitch portion 83. The motor 23B can be switched to rotate in the clockwise direction or to rotate in the counterclockwise direction by operating the switching switch. The rotary speed of the motor 23B changes according to the degree to which the footswitch portion 83 is depressed. The motor 23B enters a stopped state in a state in which the footswitch portion 83 is not depressed.

Reference character 20B in FIG. 4 and FIG. 6 denotes an electric cable 20B. The electric cable 20B includes a first connection portion 21B and a second connection portion 22B. The first connection portion 21B is detachably attachable to an electrical connection portion 3ac of the operation portion 3B. The second connection portion 22B is detachably attachable to the apparatus connection port 15s of the control apparatus 15.

When the footswitch portion 83 is depressed in a state in which the first connection portion 21B of the electric cable 20B is connected to the electrical connection portion 3ac, and the second connection portion 22B is connected to the apparatus connection port 15s, a motor driving signal is generated by the control portion. The motor driving signal is outputted to the motor 23B through the electric cable 20B. As a result, the rotary shaft 23a of the motor 23B is rotationally driven. The rotary shaft 23a is rotatable in the clockwise and counterclockwise directions.

A signal wire that is detachably attachable to the motor encoder 25B is inserted through the inside of the electric cable 20B. The rotary speed of the motor 23B is detected by the motor encoder 25B, and is thereafter outputted to the control apparatus 15 through the electric cable 20B.

In the present embodiment, the rotary shaft 23a of the motor 23B and the first end of the drive shaft 30B are coupled by a coupling 45. The coupling 45 is constituted by a first fitting 46 and a second fitting 47. The first fitting 46 is provided at the first end of the drive shaft 30B. The second fitting 47 is provided on the rotary shaft 23a.

The drive shaft 30B transmits a driving force of the motor 23B to a transmission gear 75. The transmission gear 75 is fixedly provided at the second end of the drive shaft 30B. The drive shaft 30B is a flexible shaft. The outer circumference of the drive shaft 30B is covered by the protective tube 33, and the drive shaft 30B is inserted inside the insertion portion 2B in that state.

The drive shaft 30B of the present embodiment is a shaft for right rotation that rotates in the clockwise direction when viewing the second end from the first end side as shown by an arrow Y6 in FIG. 6. In the drive shaft 30B, a torsional rigidity with respect to right rotation is set so as to be higher than a torsional rigidity with respect to left rotation.

Note that the first end of the drive shaft 30B protrudes more than the end portion on the first side of the protective tube 33. The second end of the drive shaft 30B protrudes more than the end portion on the second end side of the protective tube 33.

In the present embodiment, the insertion assisting mechanism portion 70 generates a first propulsive force that advances the insertion portion 2B as a result of the helical-shaped portion 72 rotating clockwise when viewing the assistance mechanism portion 70 from the operation portion 3B side as described above.

In the present embodiment, the transmission gear 75 and a gear portion 76g of the tube body rotation portion 76 constitute a drive mechanism portion. The tube body rotation portion 76 includes the gear portion 76g that intermeshes with the transmission gear 75 on an inner circumferential face side. The tube body 71 of the insertion assisting mechanism portion 70 is fixedly provided in an integrated manner on the outer circumferential face of the tube body rotation portion 76. The gear portion 76g protrudes to the outer side of the third connecting tube 123 from a through-hole 123h.

The transmission gear 75 can rotate together with the drive shaft 30B. The tube body 71 can rotate together with the tube body rotation portion 76. Accordingly, when the motor 23B is rotationally driven in the clockwise direction, the drive shaft 30B of the present embodiment rotates in the second rotational direction. Further, when the motor 23B is rotationally driven in the counterclockwise direction, the drive shaft 30B rotates in the first rotational direction.

In the present embodiment, the drive shaft 30B is configured so that, when the rotary shaft 23a of the motor 23B is rotated in the clockwise direction, the drive shaft 30B rotates in the second rotational direction that is the direction of a right rotation with respect to which the torsional rigidity is set so as to be higher than for a left rotation.

When the drive shaft 30B is rotated in the clockwise direction, as shown in FIG. 7, the transmission gear 75 is rotated in an arrow Y7 direction in the figure. Further, the insertion assisting mechanism portion 70 is rotated in the same direction as the arrow Y7. As a result, the insertion assisting mechanism portion 70 generates the first propulsive force that causes the insertion portion 2B to advance.

Note that reference numeral 124 denotes an O-shaped ring. The O-shaped ring 124 closely contacts the inner circumferential face of the tube body rotation portion 76 and also closely contacts the outer circumferential face of the third connecting tube 123. A pair of the O-shaped rings 124 are configured so that the insertion assisting mechanism portion 70 is rotatable with respect to the insertion portion 2B while maintaining watertightness between the inner circumferential face of the tube body rotation portion 76 and the outer circumferential face of the third connecting tube 123.

An action of the endoscope apparatus 100B will now be described.

In the endoscope apparatus 100B, the connection connector 5B of the endoscope 1B is connected to the connector connection portion 11s. The first connection portion 21B of the electric cable 20B is connected to the electrical connection portion 3ac of the operation portion 3B, and the second connection portion 22B is connected to the apparatus connection port 15s. The footswitch connector portion 81 of the external switch 80 is connected to the foot switch connection port 15r.

When operating the endoscope 1B of the endoscope apparatus 100B, the surgeon places the light source apparatus 11, the display processor 12, the monitor 13, and the control apparatus 15 in a driven state. Further, the surgeon operates the external switch 80 and depresses the footswitch portion 83 to set a state in which the first propulsive force is obtained.

While observing an endoscopic image that is displayed on the monitor 13, the surgeon performs a manual operation to insert the insertion portion 2B into the body from, for example, the anus. Thereafter, while observing the endoscopic image, the surgeon performs a manual operation or depresses the footswitch portion 83 to insert the insertion portion 2B into a deep part of the large intestine.

Simultaneously with depression of the footswitch portion 83 by the surgeon, the control portion of the control apparatus 15 generates a motor driving signal that is based on an instruction signal from the footswitch portion 83. The control portion of the control apparatus 15 outputs the driving signal to the motor 23B.

Thereupon, the rotary shaft 23a of the motor 23B rotates in the clockwise direction, and the rotational driving force thereof is transmitted to the drive shaft 30B through the coupling 45. As a result, the drive shaft 30B is rotated in the clockwise direction that is the second rotational direction which is the same as the rotational direction of the rotary shaft 23a. Accordingly, as shown in FIG. 7, the insertion assisting mechanism portion 70 rotates in the clockwise direction and generates the first propulsive force.

As a result, while the observing the endoscopic image, the surgeon advances the insertion portion 2B towards the deep part while obtaining the first propulsive force. At this time, since the surgeon can advance the insertion portion 2B while obtaining the first propulsive force, the surgeon can smoothly insert the insertion portion 2B towards the deep part.

Subsequently, if the surgeon determines based on the endoscopic image that the distal end portion 2a has reached the target site, the surgeon stops depressing the footswitch portion 83. Consequently, rotation of the insertion assisting mechanism portion 70 is stopped.

Next, the surgeon carries out an endoscopic examination while performing an operation to pull back the insertion portion 2B. At this time, the surgeon selects whether to manually retract the insertion portion 2B or to retract the insertion portion 2B while obtaining the second propulsive force.

That is, in the case of performing the endoscopic examination while manually pulling back the insertion portion 2B, the surgeon stops the rotation of the insertion assisting mechanism portion 70. On the other hand, in the case of performing the endoscopic examination while obtaining the second propulsive force and retracting the insertion portion 2B, after operating the switching switch to select to obtain the second propulsive force, the surgeon depresses the footswitch portion 83.

When the footswitch portion 83 is depressed, the control portion of the control apparatus 15 generates a motor driving signal that is based on an instruction signal from the switch portion 83, and outputs the driving signal to the motor 23B. Thereupon, the rotary shaft 23a of the motor 23B rotates in the counterclockwise direction, and the rotational driving force thereof is transmitted to the drive shaft 30B through the coupling 45. As a result, the drive shaft 30B is rotated in the first rotational direction, and the insertion assisting mechanism portion 70 is rotated in the counterclockwise direction and generates the second propulsive force.

While the observing the endoscopic image, the surgeon retracts the insertion portion 2B towards the anus while obtaining the second propulsive force. At this time, since the surgeon can retract the insertion portion 2B while obtaining the second propulsive force, the surgeon can perform the endoscopic examination while holding the insertion portion 2B with a slight amount of force.

Thereafter, when the distal end portion 2a is extracted from the anus, the surgeon stops depressing the footswitch portion 83 to thereby stop rotation of the insertion assisting mechanism portion 70.

Thus, the endoscope 1B is constructed in which the rotational driving force of the motor 23B is transmitted from the first end of the drive shaft 30B to the second end thereof to rotate the transmission gear 75 and rotationally drive the insertion assisting mechanism portion 70 in a desired direction. In this confirmation, the winding direction in which the torsional rigidity of the drive shaft 30B is set to be high, the rotational direction of the drive shaft 30B, and the rotational direction in which the load applied to the insertion assisting mechanism portion 70 is large are made to match each other.

As a result, when transmitting the rotational driving force of the motor 23B to the insertion assisting mechanism portion 70 through the drive shaft 30B, the drive shaft 30B is twisted in the winding direction. Therefore, the drive shaft 30B reliably transmits the rotational driving force of the motor 23B to the insertion assisting mechanism portion 70 without the transmission efficiency decreasing, and the first propulsive force that advances the insertion portion 2B can be obtained. In other words, a situation in which advancement of the insertion portion 2B to a deep part is hindered due to the first propulsive force decreasing is prevented from arising.

Note that in a case where the drive shaft 30B is rotated in the first rotational direction that is the opposite direction to the direction in which the torsional rigidity of the shaft 30B is set to a high torsional rigidity, and the rotational driving force of the motor 23B is transmitted to the drive mechanism portion to rotate the insertion assisting mechanism portion 70 and obtain the first propulsive force, the drive shaft 30B is twisted in the opposite direction to the winding direction. Consequently, there is a risk that the first propulsive force will decrease due to a reduction in the transmission efficiency of the rotational driving force of the motor 23B and it will become difficult to advance the insertion portion 2B.

Further, a configuration may also be adopted in which the drive cable 20 is used instead of the electric cable 20B of the present embodiment, and the driving force of the motor 23 of the drive cable 20 is transmitted to a receiving bevel gear provided in the operation portion through a feeding bevel gear. In this configuration, the rotational direction of the rotary shaft 23a and the rotational direction of the drive shaft 30B are reversed by means of the bevel gear. Accordingly, in the drive shaft having this configuration, the torsional rigidity with respect to left rotation is set so as to be higher than the torsional rigidity with respect to right rotation.

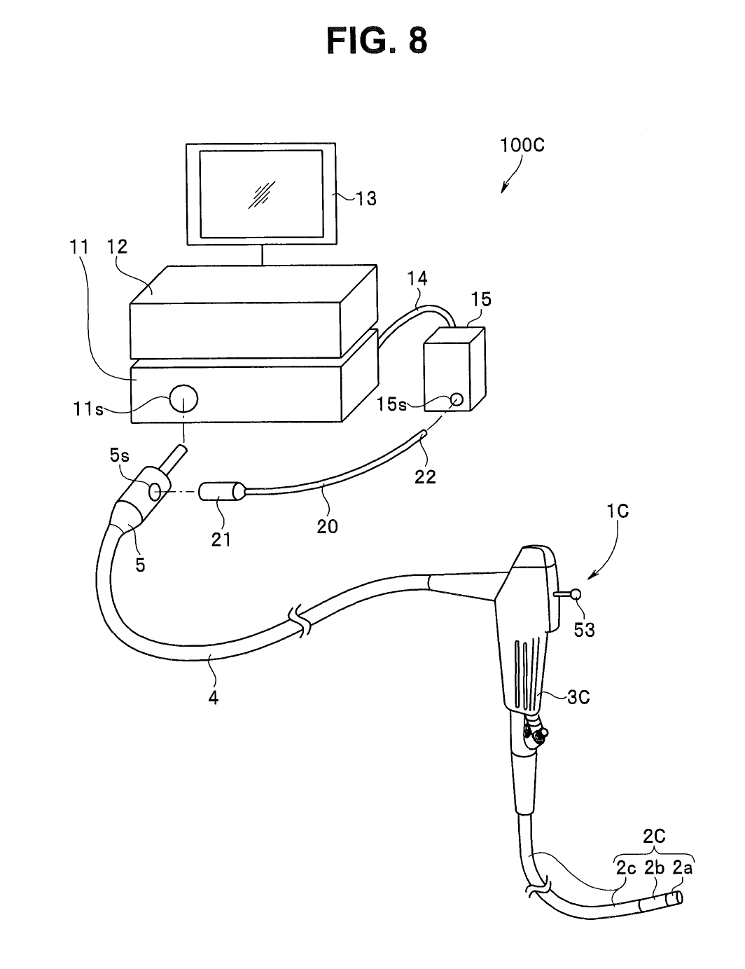

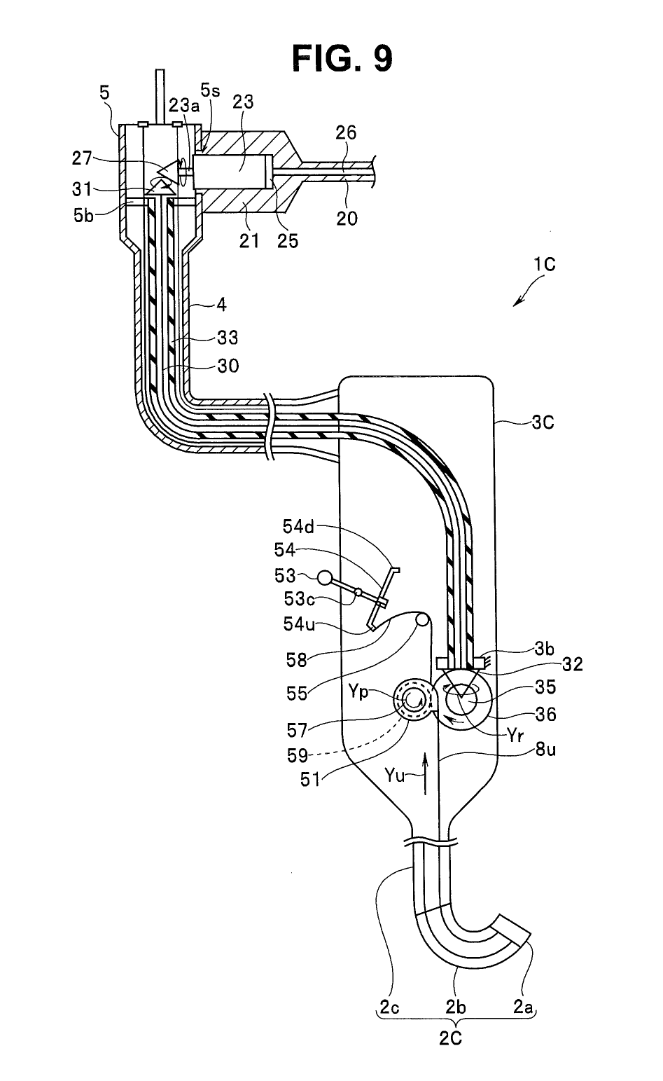

FIG. 8 and FIG. 9 relate to a third embodiment of the present invention. FIG. 8 is a view that illustrates an endoscope apparatus of the third embodiment. FIG. 9 is a view that illustrates a power-assist mechanism that actuates a bending function of a bending portion by electrical driving.

The configuration of an endoscope apparatus 100C according to the present embodiment that is illustrated in FIG. 8 and FIG. 9 is substantially the same as the endoscope apparatus 100 illustrated in FIG. 1 and FIG. 2, and members that are the same as in the above described first embodiment are denoted by the same reference numerals and a description of such members is omitted hereunder.

An endoscope 1C of the present embodiment includes a power-assist mechanism instead of the electrical bending mechanism that bends the bending portion 2b. Further, a joy stick 53 is provided as an operation instruction member in an operation portion 3C of the endoscope 1C. Therefore, the differences with respect to the configuration of the first embodiment are mainly described hereunder.

Note that, with respect to FIG. 9 that illustrates a configuration that includes the power-assist mechanism, to simplify the drawing, only a configuration that causes the bending portion 2b to bend in the upward direction will be described. That is, a description regarding a configuration that causes the bending portion 2b to bend in the downward direction and a configuration that causes the bending portion 2b to bend in the left and right directions is omitted hereunder.

As shown in FIG. 8, the joy stick 53 is provided on the operation portion 3C. The joy stick 53 is an operation instruction member that causes the bending portion 2b to bend in the upward, downward, left, and right directions.

As shown in FIG. 9, the joy stick 53 has a center of rotation 53c. The joy stick 53 is tiltable in each of the upward, downward, left, and right directions with respect to the center of rotation 53c. For example, a cross-shaped hanging frame 54 is integrally fixed to an end portion of the joy stick 53. The proximal end of the upward wire 8u is fixed to a predetermined end portion for upward bending 54u of the hanging frame 54. The distal end of the upward wire 8u is fixedly provided in a predetermined upward direction of the bending portion 2b.

A portion partway along the upward wire 8u is wound around a C-shaped ring 51 and is also disposed on a guide roller 55. The C-shaped ring 51 has a C-shaped ring shape in which the diameter can be decreased. The C-shaped ring 51 in which the diameter can be decreased is disposed in a loosely fitting manner on the outer circumference of the pulley 57.

Note that in the present embodiment, a downward wire, a right wire, and a left wire that are not shown in the figure and which are inserted through the inside of the insertion portion 2 are respectively wound around the outer circumference of the C-shaped rings 51 corresponding to the respective wires and are also disposed on the guide roller 55. The C-shaped rings that correspond to the respective wires are disposed in a loosely fitting manner on the outer circumference of the pulley 57, respectively. Further, the proximal ends of the respective wires are fixed to an end portion for downward bending 54d, an end portion for left bending (unshown), and an end portion for right bending (unshown) of the hanging frame 54 that are previously determined for each of the wires.

The upward wire 8u according to the present embodiment is not wound around the pulley 7 of the first embodiment, but rather is windingly disposed on the C-shaped ring 51 that is capable of contacting with a frictional force against the outer circumference of the pulley 57.

The C-shaped ring 51 is configured so that the diameter thereof is decreased as a result of the upward wire 8u being pulled accompanying a tilting operation of the joy stick 53. In the C-shaped ring, a clearance between the inner circumferential face of the C-shaped ring 51 and the outer circumferential face of the pulley 57 gradually narrows as the diameter thereof is decreased.

The diameter of the C-shaped ring 51 then decreases and the inner circumferential face of the ring 51 contacts the outer circumferential face of the pulley 57, and accompanying the generation of a frictional force, the C-shaped ring 51 is rotated together with the pulley 57 in one direction. As a result of the C-shaped ring 51 being rotated together with the pulley 57, a rotary force is transmitted to the upward wire 8u so that the wire 8u is pulled. The rotary force of the pulley 57 that is transmitted to the upward wire 8u from the C-shaped ring 51 is a pulling assistance force.

Note that, after contacting the outer circumference of the pulley 57, the C-shaped ring 51 is not rotated integrally with the pulley 57, but rather is rotated in the same direction as the pulley 57 while sliding over the outer circumference of the pulley 57.

The endoscope apparatus 100C includes an electric drive mechanism that is designed to reduce the amount of force of an operation to tilt the joy stick 53. The electric drive mechanism (referred to as “power-assist mechanism”) includes the motor 23, the drive shaft 30, and the pulley 57 as principal components.

In the present embodiment, the pulley 57 is included in a drive mechanism portion. The drive mechanism portion is configured to include the pulley 57, a first spur gear 59, the second spur gear 36, and the driving-force receiving bevel gear (hereunder, referred to as “receiving gear”) 35. The first spur gear 59 is provided integrally with the pulley 57. The receiving gear 35 is provided integrally with the second spur gear 36.

The pulley 57 is rotatable together with the first spur gear 59 in an arrow Yp direction that is a single direction. The second spur gear 36 is rotatable together with the receiving gear 35 in the opposite direction to the arrow Yp direction that is a single direction.

The second spur gear 36 is provided inside the operation portion 3, and is intermeshed with the first spur gear 59. The second bevel gear 32 of the drive shaft 30 is intermeshed with the receiving gear 35.

In the present embodiment, similarly to the first embodiment, a configuration is adopted such that in a state in which the drive cable 20 is connected to the connection connector 5, the drive shaft 30 rotates in the second rotational direction when the rotary shaft 23a of the motor 23 is rotated in the clockwise direction.

When the pulley 57 is rotated in the arrow Yp direction in the figure, the pulley 57 pulls the upward wire 8u in the arrow Yu direction in the figure to cause the bending portion 2b to bend in the upward direction.

Note that, in the present embodiment, when bending the bending portion 2b in the downward direction also, the downward wire is pulled in an arrow Yd direction in the figure. Likewise, when bending the bending portion 2b in the right direction, the right wire is pulled in the arrow Yd direction in the figure, and when bending the bending portion 2b in the left direction, the left wire is pulled in the arrow Yd direction in the figure.

That is, the pulley 57 of the present embodiment is always rotated in the arrow Yp direction. Accordingly, the drive shaft 30 is a shaft for right rotation that rotates in the second rotational direction as indicated by an arrow Yr. In the drive shaft 30, the torsional rigidity with respect to right rotation is set so as to be higher than the torsional rigidity with respect to left rotation.

Note that the pulley potentiometer 40, the knob shaft potentiometer 42, the second cable 43, and the third cable 41 that are used in the above described first embodiment are not required in the present embodiment.

An action of the endoscope apparatus 100C will now be described.

In the endoscope apparatus 100C, the connection connector 5 of the endoscope 1C is connected to the connector connection portion 11s. The first connection portion 21 of the drive cable 20 is connected to the connection portion 5s of the connection connector 5. The second connection portion 22 of the drive cable 20 is connected to the apparatus connection port 15s.

When operating the endoscope 1C of the endoscope apparatus 100C, a surgeon places the light source apparatus 11, the display processor 12, the monitor 13, and the control apparatus 15 in a driven state. Thereupon, the control portion of the control apparatus 15 outputs a predetermined motor driving signal to the motor 23. As a result, the rotary shaft 23a of the motor 23 is rotated clockwise. The rotational driving force of the motor 23 is transmitted to the drive shaft 30 via the feeding gear 27 and the first bevel gear 31. As a result, the drive shaft 30 rotates in the second rotational direction.

The rotation of the drive shaft 30 is transmitted via the second bevel gear 32 to the receiving bevel gear 35, and thereafter is transmitted to the pulley 57 via the second spur gear 36 and the first spur gear 59. As a result, the pulley 57 rotates in the arrow Yp direction. The pulley 57 then continues to rotate in the arrow Yp direction.

In the above described state, when the surgeon tilts the joy stick 53 in order to bend the bending portion 2b in, for example, the upward direction, the upward wire 8u is pulled. Thereupon, the C-shaped ring 51 for upward bending is decreased in diameter, and the inner circumferential face of the ring 51 contacts the outer circumferential face of the pulley 57 that is continuously rotating in the arrow Yp direction.

As a result, the C-shaped ring 51 for upward bending rotates together with the pulley 57 in a single direction, and thus the upward wire 8u is pulled in the direction shown by the arrow Yu and the bending portion 2b bends in the upward direction.

Note that, the above described action is also the same in a case of causing the aforementioned bending portion 2b to bend in the downward direction, the right direction, or the left direction. That is, among bending wires that are respectively wound around C-shaped rings corresponding to four bending directions, when any one or two of the bending wires are pulled, one or two C-shaped rings 51 corresponding to the pulled wires are decreased in diameter. Thereupon, the one or two C-shaped rings 51 contact the pulley 57 with a frictional force. As a result, the C-shaped rings 51 are rotated together with the pulley 57 in the same direction, and the corresponding one or two wires among the upward, downward, left and right wires are pulled. Thereupon, the bending portion 2b bends in any one direction among the upward, downward, left and right directions, or in a direction that combines either one of the upward and downward directions with either one of the left and right directions, for example, the right-downward direction or the left-upward direction.

Thus, the endoscope 1C is constructed that is designed to reduce the amount of a pulling force that pulls the bending wire 8u when the rotational driving force of the motor 23 is transmitted from the first end of the drive shaft 30 to the second end thereof to cause the pulley 57 to rotate in the predetermined arrow Yp direction. In this confirmation, the winding direction in which the torsional rigidity of the drive shaft 30 is set to so as to be high, the rotational direction of the drive shaft 30, and the rotational direction of the pulley 57 are made to match each other.

As a result, when transmitting the rotational driving force of the motor 23 to the pulley 57 through the drive shaft 30, the drive shaft 30 is twisted in the direction in which the rigidity is set so as to be high. Therefore, when transmitting the rotational driving force, the drive shaft 30 can reliably transmit the rotational driving force without the transmission efficiency being decreased, and can reliably reduce the amount of a pulling force that pulls the bending wire 8u.

Further, one drive shaft 30, one motor 23, and one pulley 57 are provided in the configuration of the present embodiment. Therefore, the configuration that electrically bends the bending portion 2b of the present embodiment can be simplified relative to the configuration of the first embodiment.

Note that in a case where a configuration is adopted in which the drive shaft 30 is caused to rotate in the first rotational direction that is the opposite direction to the direction in which the torsional rigidity of the shaft 30 is set to a high torsional rigidity to thereby transmit the rotational driving force of the motor 23 to the drive mechanism portion to cause the pulley 57 to rotate in the arrow Yp direction, since the drive shaft 30 is twisted continuously in the direction in which the rigidity is low, the transmission efficiency of the rotational driving force gradually decreases with the passage of time, and there is a risk that it will become difficult to transmit an adequate rotational driving force.

Further, in the present embodiment, although the joy stick 53 is adopted as an operation instruction member, an operation knob may also be used, similarly to the first embodiment.

It should be understood that the present invention is not limited only to the above described embodiments, and various modifications thereof can be made without departing from the spirit and scope of the invention. For example, a configuration may also be adopted so that the rigidity increases when a torque shaft is rotated with respect to a rotational direction of the torque shaft that causes the bending portion to bend in the right direction.

What is claimed is:

1. An endoscope apparatus comprising:
an insertion portion to be inserted into a subject;
an insertion assisting mechanism portion that is provided on an outer circumference of the insertion portion and is rotatable in a first rotational direction for advancing the insertion portion inside the subject, or a second rotational direction that is an opposite direction to the first rotational direction and is a direction for retracting the insertion portion towards outside of the subject;
a drive portion that generates a driving force for causing the insertion assisting mechanism portion to rotate with respect to the insertion portion;
a drive shaft that can be rotated by a driving force of the drive portion, and a torsional rigidity of the drive shaft in a fourth rotational direction that is an opposite direction to a third rotational direction is set so as to be higher than a torsional rigidity in the third rotational direction; and
a drive mechanism portion that, by means of the drive shaft rotating in the fourth rotational direction, causes the insertion assisting mechanism portion to rotate in the first rotational direction.

2. The endoscope apparatus according to claim 1, wherein a load that is applied when the insertion assisting mechanism portion rotates in the first rotational direction to cause the insertion portion to advance inside the subject is greater than a load that is applied when the insertion assisting mechanism portion rotates in the second rotational direction to cause the insertion portion to retract towards the outside of the subject.
